(19) United States
(12) Patent Application Publication
(10) Pub. No.: US 2018/0328827 A1
(43) Pub. Date: Nov. 15, 2018

(54) WELLBORE MATERIAL CONTINUOUS HARDNESS TESTING METHODS AND TOOLS

(71) Applicant: Halliburton Energy Services, Inc., Houston, TX (US)

(72) Inventors: Vladimir Nikolayevich Martysevich, Spring, TX (US); Harold Grayson Walters, Tomball, TX (US); Michelle Renee Sansil, New Caney, TX (US); Luis A. Matzar, Humble, TX (US); Jesse C. Hampton, Conroe, TX (US); Ronald Glen Dusterhoft, Katy, TX (US); Jie Bai, Katy, TX (US)

(73) Assignee: Halliburton Energy Services, Inc., Houston, TX (US)

(21) Appl. No.: 15/774,197

(22) PCT Filed: Dec. 29, 2015
(86) PCT No.: PCT/US15/67803

§ 371 Date: May 7, 2018

(51) Int. Cl. G01N 3/46; E21B 49/00

(52) U.S. Cl. CPC G01N 3/46; E21B 49/006

(57) ABSTRACT

A method for continuous measuring of hardness in subterranean formation material includes pressing the tip of an indenter in an indentation assembly against the surface of formation material with a prescribed force; creating an indentation; measuring the applied force and/or the depth of the indentation; moving at least one of the indenter across the surface of the material, the material across the surface of the indenter, and combinations thereof, with constant axial force applied to the tip of the indenter to create an indentation path; and measuring applied force, indenter displacement, and lateral displacement while the indenter is creating the indention path, wherein the applied force, indenter displacement, and lateral displacement are used to determine the continuous hardness of the formation material. An apparatus includes a specimen table and an indention assembly including an indention tip. Another apparatus includes a tool body with caliper arms and an indention assembly.

### BACKGROUND

When hydrocarbon-producing wells or other boreholes are being drilled or prepared for fracturing treatments, it is frequently necessary or desirable to determine the nature of the strata being drilled, such as the formation's resistivity, porosity, density and the hardness of the formation walls. Often times, the mechanical properties of formation core sections with highly variable properties and dense layering must be acquired. Typical testing procedures involve obtaining a core to the formation material and testing it on the surface. These methods include scratch tests and/or crush tests. Both of these are destructive tests that are very labor intensive both in obtaining the core sample below the surface and testing the core on the surface.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIGS. 1A, B are force to displacement graphs of point indentation examples.

FIG. 2 is an apparatus for the evaluation of rock mechanical properties according to embodiments of the disclosure.

FIG. 3 is an apparatus for use downhole to evaluate the rock mechanical properties according to embodiments of the disclosure.

FIG. 4 is a photograph of a lab experiment on a laminated shale rock sample utilizing a load from with axial and shear capabilities according to embodiments of the disclosure.

FIG. 5 is a showing continuous and point hardness measurements in the lab experiment utilizing the specimen shown in FIG. 4.

### DETAILED DESCRIPTION

The present invention generally relates to determining the mechanical properties of formation materials by conducting continuous indentation tests.

Embodiments of the invention are directed to methods of mechanical property testing and apparatuses for conducting the tests downhole and on the surface.

Measurement Methods

In an embodiment, the measurement method utilizes a spherical or roller shaped indentation tip and is based on the elastic and plastic indentation of the material. First, the tip is pressed against the surface of the investigated object with a prescribed force. There are relationships described in the literature between hardness measurements and mechanical rock properties. For example, reduced Young's modulus can be determined using the indentation test. By measuring applied force and the depth of the indentation, the hardness number BHN (1) and from Bulychev et al., reduced Young's Modulus Eᵣ (2 and 3) may be calculated.

$$\begin{matrix}{BHN}_{i} = \frac{P}{π D {h}_{f}} & ( 1 ) \\ S = \frac{dP}{dh} = \frac{2}{\sqrt{π}} {E}_{r} \sqrt{A} & ( 2 ) \\ {E}_{r} = S \frac{\sqrt{π}}{2 \sqrt{A}} & ( 3 )\end{matrix}$$

where P is the applied force, D—indenter diameter, h_{f}—final indenter displacement, S—elastic contact stiffness defined from the slope of the initial section of the unloading curve, A—elastic contact area projection. The displacement of an indenter is recorded both in increasing and decreasing load and a load-displacement curve is created. This may be used to define the indent projection area from its depth under the highest load.

After the point measurement, the indenter begins to move across the surface of the material with constant axial force creating the indentation path. The axial force should not exceed material strength so the rolling or sliding indenter can remain on the surface and perform continuous indentation. Applied force and indenter displacement as well as lateral displacement are measured during the continuous indentation process. At some points along an adjacent line, additional point indentation measurements can be performed for additional mechanical property calculations.

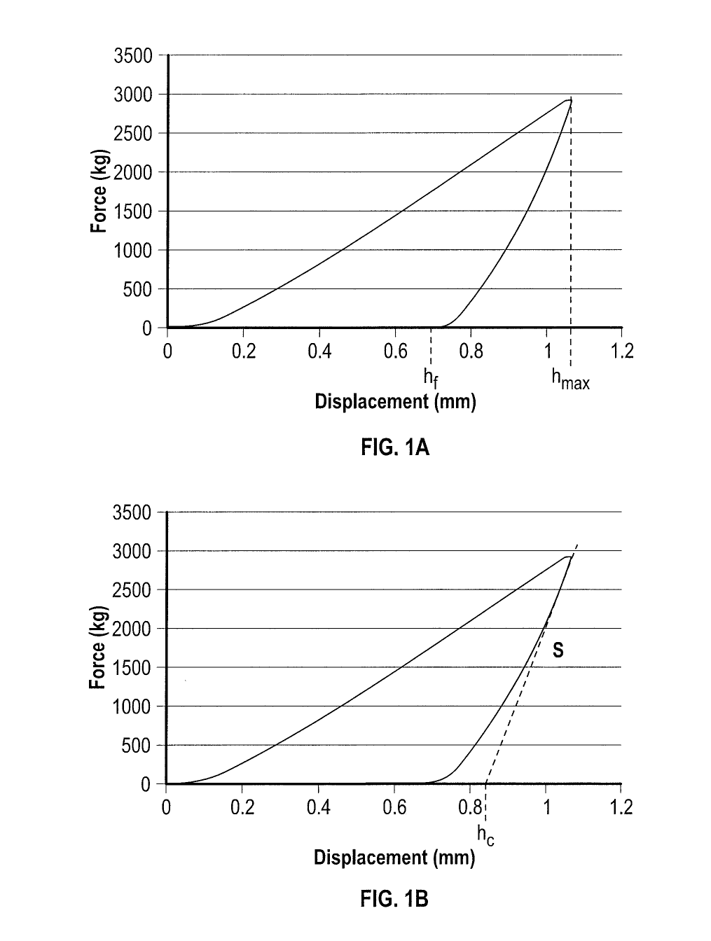

The created line measurements, using sample measurements for a typical material, are graphed in FIG. 1 as force vs displacement, and represent the change of hₘₐₓ across the surface of the investigated material normalized by a reduced supporting area. The elastic contact displacement is represented by h_{c}. By utilizing the hₘₐₓ to h_{f} and hₘₐₓ to h_{c} ratios, mechanical properties may be characterized.

The linear relationship of hardness to ultimate tensile strength (UTS) is well known in metallurgy, although there is no direct analytical conversion. Roughly, an estimate of UTS (psi)=515×BHN for BHN≤175 and 490×BHN for BHN>175.

In an embodiment, a method for measuring continuous hardness in subterranean formation material, the method comprises: pressing the tip of an indenter in an indentation assembly against the surface of formation material with a prescribed force; creating an indentation; measuring the applied force and the depth of the indentation; moving at least one of the indenter across the surface of the material, the material across the surface of the indenter, and combinations thereof, with constant axial force applied to the tip of the indenter to create an indentation path; and measuring applied force, indenter displacement, and lateral displacement while the indenter is creating the indention path, wherein the applied force, indenter displacement, and lateral displacement are used to determine the continuous hardness of the formation material. In one embodiment, the indentation assembly is part of an apparatus comprising: a specimen table with a slot for at least one indenter; and an indention assembly comprising at least one indenter with a force and displacement sensor, wherein the indention assembly is installed under the specimen table such that the indenter may contact a specimen of formation material by extending through the hole, the indenter configured to press against the specimen as the specimen is moved across the specimen table, the indenter including a rolling or sliding indentation tip which dents the specimen. In another embodiment, the method may further comprise at least one motion sensor on the surface of the specimen table. The at least one motion sensor may be at least one of mechanical, optical, electromagnetic, and combinations thereof. The specimen table may have at least one of a flat shape, concave semi-cylindrical shape, and combinations thereof. The at least one indenter tip shape may be at least one of spherical, pointed, elliptical, wheel, and combinations thereof. The specimen may be pressed against the indenter by using at least one of hand force, calibrated weight, mechanical means, and combinations thereof. The mechanical means may be at least one of a spring, a clamp, hydraulic actuator, electromechanical actuator, and combinations thereof. The method may also include a computer to receive the data from the force and displacement sensors.

In another embodiment, the method above includes an apparatus comprising a tool body configured to travel through a wellbore, said tool body comprising: wellbore diameter measuring device, wherein the wellbore diameter measuring device is configured to provide a base line wellbore geometry; and an indention assembly, wherein the indention assembly comprises at least one indenter with a force and displacement sensor, the indenter installed behind the wellbore diameter measuring device and configured to press against the wellbore face, the indenter including a rolling or sliding indentation tip which dents the formation. The wellbore diameter measuring device may be a caliper assembly. The caliper assembly may comprise at least one caliper arm, pivotally mounted for radial extension radially outwardly from the tool body to extend the arm tip outward for tip engagement with the surrounding wellbore wall. The apparatus may be configured to perform at least one of a continuous path of indentations, a series of point indentations, and combinations thereof. In an embodiment, there are at least two caliper arms and at least two indenters. The caliper arms may be located on the caliper assembly such that opposite sides of the wellbore face are contacted. The at least one indenter tip shape may be at least one of spherical, pointed, elliptical, wheel, and combinations thereof.

In an embodiment, the formation samples may include one selected from full diameter core samples, slabbed core sections, drill cuttings, rock fragments, sidewall plugs from field well logs, material obtained from any other type of exposed surface (e.g., surfaces exposed during mining operations or other drilling operations), and combinations thereof. Continuous measurements may be conducted along any direction in relation to bedding orientation, fracture orientation, or any other textural feature, including radial, axial or transverse orientations. Continuous measurements may be made by a single pass or multiple longitudinal passes.

Apparatuses

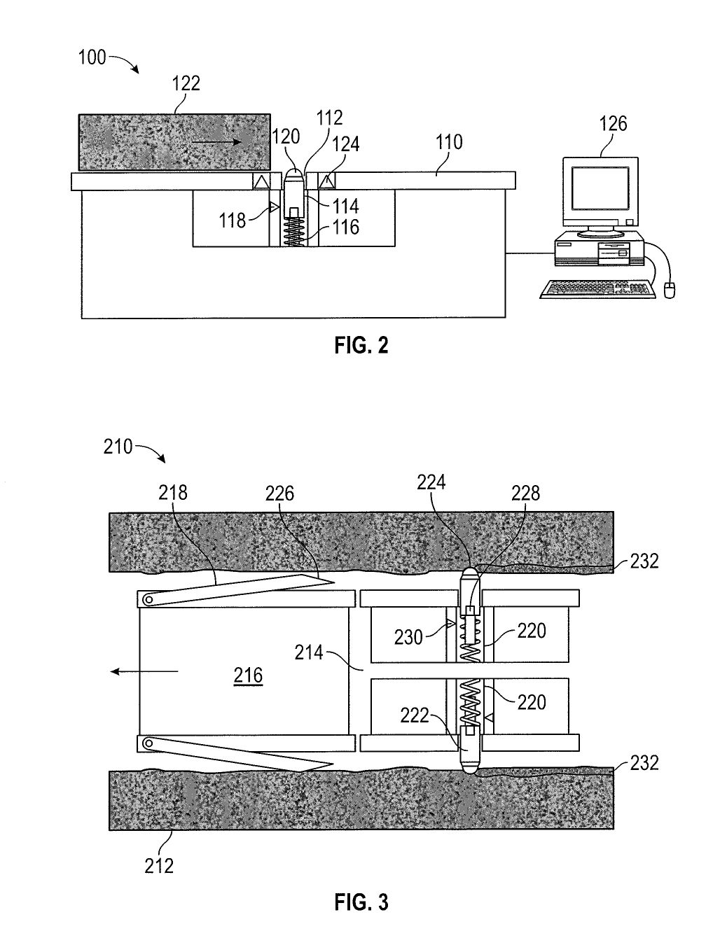

FIGS. 2 and 3 represent two possible embodiments of apparatus according to the disclosure, showing its main components and working cycle, and are not limiting the disclosure thereto.

Specimen Table

Referring to FIG. 2, apparatus 100 includes specimen table 110, with a hole 112 configured to accept an indention assembly 114. The indention assembly 114 includes at least one indenter 120, with a force sensor 116 and a displacement sensor 118. The indention assembly 114 is installed under specimen table 110 such that the indenter 120 may contact a specimen 122 by extending through the hole 112 as the specimen 122 moves across the specimen table 110. The apparatus may include at least one optional motion sensor 124, as well as an optional PC 126 for collecting data from the sensors.

In an embodiment, an apparatus for testing continuous hardness in a specimen from a subterranean formation comprises: a specimen table with a slot for at least one indenter; and an indention assembly comprising at least one indenter with a force and displacement sensor, wherein the indention assembly is installed under the specimen table such that the indenter may contact a specimen by extending through the hole, the indenter configured to press against the specimen as the specimen is moved across the specimen table, the indenter including a rolling or sliding indentation tip which dents the specimen. In another embodiment, the apparatus may further comprise at least one motion sensor on the surface of the specimen table. The at least one motion sensor may be at least one of mechanical, optical, electromagnetic, and combinations thereof. The specimen table may have at least one of a fiat shape, concave semi-cylindrical shape, and combinations thereof. The at least one indenter tip shape may be at least one of spherical, pointed, elliptical, wheel, and combinations thereof. The specimen may be pressed against the indenter by using at least one of hand force, calibrated weight, mechanical means, and combinations thereof. The mechanical means may be at least one of a spring, a clamp, hydraulic actuator, electromechanical actuator, and combinations thereof. The apparatus may also include a computer to receive the data from the force and displacement sensors.

The shape of the top of the specimen table may be altered to accommodate different specimen shapes. For example, a cylindrical core may be moved across the table in a concave semi-cylindrical groove. If the specimen has a flat face, then the table may have a flat surface.

Downhole Tool

Referring to FIG. 3, apparatus 200 may be used to test continuous hardness downhole in a wellbore 212 and includes, a tool body 214 configured to travel through wellbore 212, a caliper assembly 216 and an indention assembly 220. The caliper assembly 216 comprises at least one caliper arm 218, pivotally mounted for radial extension radially outwardly from the too body 214 to extend the arm tip 226 outward for tip engagement of the surrounding wellbore wall 212. The indention assembly 220 includes at least one indenter 222 with a force sensor 228 and a displacement sensor 230. The indenter 222 is installed behind the caliper arm 218 and is configured to press against the wellbore face 224. The indenter 222 includes a rolling or sliding indention tip 224 which dents the formation 212 to create an indented line 232 on the wellbore face.

In an embodiment, an apparatus comprises a tool body configured to travel through a wellbore, said tool body comprising: a wellbore diameter measuring device, wherein the wellbore diameter measuring device is configured to provide a base line wellbore geometry; and an indention assembly, wherein the indention assembly comprises at least one indenter with a force and displacement sensor, the indenter installed behind the wellbore diameter measuring device and configured to press against the wellbore face, the indenter including a rolling or sliding indentation tip which dents the formation. The wellbore diameter measuring device may be a caliper assembly. The caliper assembly may comprise at least one caliper arm, pivotally mounted for radial extension radially outwardly from the tool body to extend the arm tip outward for tip engagement with the surrounding wellbore wall. The apparatus may be configured to perform at least one of a continuous path of indentations, a series of point indentations, and combinations thereof. In an embodiment, there are at least two caliper arms or any type of wellbore diameter measuring device, and at least two indenters. The caliper arms may located on the caliper assembly such that opposite sides of the wellbore face are contacted. The at least one indenter tip shape may be at least one of spherical, pointed, elliptical, wheel, and combinations thereof.

Wellbore Diameter Measuring Device

The apparatus may include a wellbore diameter measuring device. This device may be at least one of mechanical, electronic, electromechanical, and combinations thereof. In one embodiment, the wellbore diameter measuring device is mechanical and includes caliper arms. The caliper arms may deflect outwardly from the tool body to contact the wall of the wellbore for measurement purposes. The arms may move independently of one another to position sensors in contact with the side wall of the well borehole. In general terms, the arms must be forced outwardly so that they make positive contact against the borehole wall to ensure that correct and proper measurements are obtained thereby. Ordinarily, the total number of arms is at least one, and typically two to four. In an embodiment, each pivoting arm may have an associated individual spring to provide the loading force applied to the arm to cause rotation. The distances the pivoting arms have extended from the body may be measured and recorded and may provide dimensions of the wellbore and surface depth measurements of the wellbore at particular locations. Together, these measurements may be used to map the shape of the wellbore. The measurements may also be used to provide a baseline depth for use by the indenter near the particular arm. One of skill in the art will realize that there may be a plurality of arms attached to the tool body.

Indenters

The indenters of the disclosure measure the hardness of the sample by applying pressure to the surface of the sample and measuring the force required to penetrate the sample. The indenters may roll or slide across the surface of the sample. The indenters may have tips with different shapes. In some embodiments, the shapes of the tips are at least one of spherical, pointed, elliptical, wheel, and combinations thereof. Useful materials for the indenter tips include, but are not limited to, tungsten carbide and hardened steel.

Wellbore and Formation

Broadly, a zone refers to an interval of rock along a wellbore that is differentiated from surrounding rocks based on hydrocarbon content or other features, such as perforations or other fluid communication with the wellbore, faults, or fractures.

As used herein, into a subterranean formation can include introducing at least into and/or through a wellbore in the subterranean formation. According to various techniques known in the art, equipment, tools, or well fluids can be directed from a wellhead into any desired portion of the wellbore.

It is to be recognized that the disclosed methods and apparatuses may also directly or indirectly affect the various downhole equipment and tools that may come into contact with the apparatuses during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

The invention having been generally described, the following example is given as a particular embodiment of the invention and to demonstrate the practice and advantages hereof. It is understood that the example is given by way of illustration and is not intended to limit the specification or the claims to follow in any manner.

### EXAMPLE

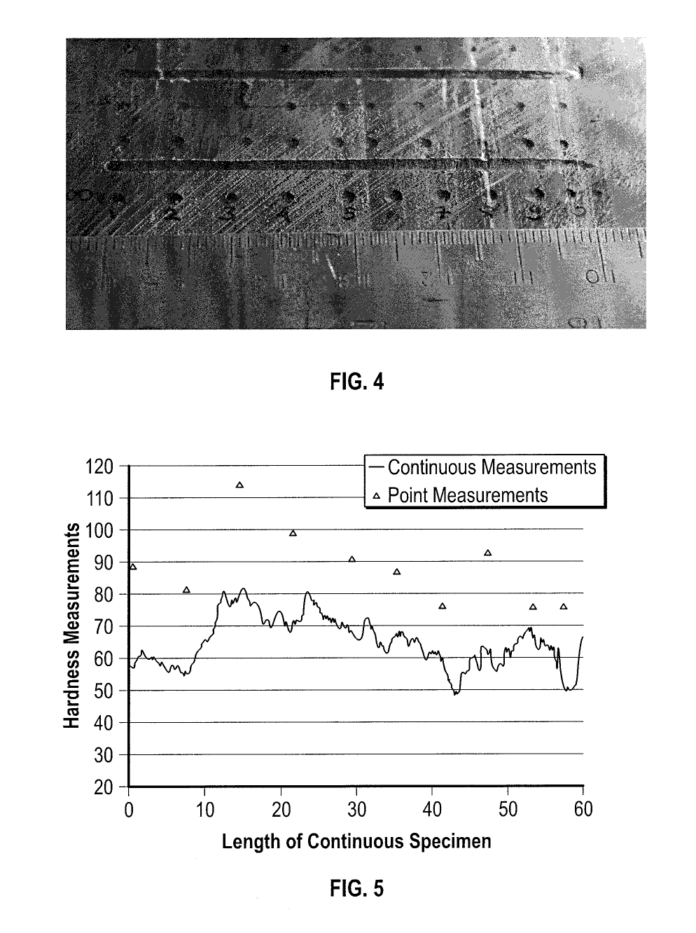

An experiment was performed in the laboratory using load frame with axial and shear capabilities. Highly laminated shale rock sample was used to perform linear hardness measurements accompanied with point indentation along an adjacent line. FIG. 4 is a photograph showing the indentations in the sample. FIG. 5 is a graph showing the continuous and point hardness measurements, as well as the continuous hardness normalized by effective area. The x-axis is the length of the continuous specimen and the y-axis is the known hardness calculated number. The results of the experiment show that continuous measurements can be used for hardness characterization of highly laminated formations. In turn, the hardness can be converted to the mechanical properties to be used in advanced fracturing designs.

One of skill in the art will realize that previous designs of equipment for continuous mechanical property measurements have a principal difference from the current invention since the current invention testing is based on the elastic and plastic indentation of the material instead of failing it in compression. The probe has a rolling or sliding indentation tip which dents formation material instead of failing it with debris creation. The invention presents an easy to use, fast and robust method and instrument to obtain mechanical properties of formation core sections and open hole mechanical logging. The analysis method is simple, straightforward, and gives a complete distribution of properties with a single test.

Embodiments disclosed herein include:

A: A method for measuring continuous hardness in subterranean formation material, the method comprising: pressing the tip of an indenter in an indentation assembly against the surface of formation material with a prescribed force; creating an indentation; measuring the applied force and the depth of the indentation; moving at least one of the indenter across the surface of the material, the material across the surface of the indenter, and combinations thereof, with constant axial force applied to the tip of the indenter to create an indentation line; and measuring applied force, indenter displacement, and lateral displacement while the indenter is creating the indention path, wherein the applied force, indenter displacement, and lateral displacement are used to determine the continuous hardness of the formation material.

B: An apparatus for testing continuous hardness in a specimen from a subterranean formation comprising: a specimen table with a slot for at least one indenter; and an indention assembly comprising at least one indenter with a force and displacement sensor, wherein the indention assembly is installed under the specimen table such that the indenter may contact a specimen by extending through the slot, the indenter configured to press against the specimen as the specimen is moved across the specimen table, the indenter including a rolling or sliding indentation tip which dents the specimen.

C: An apparatus comprising a tool body configured to travel through a wellbore, said tool body comprising: assembly wellbore diameter measuring device, wherein the wellbore diameter measuring device is configured to provide a base line wellbore geometry; and an indention assembly, wherein the indention assembly comprises at least one indenter with a force and displacement sensor, the indenter installed behind the wellbore diameter measuring device and configured to press against the wellbore face, the indenter including a rolling or sliding indentation tip which dents the formation.

Each of embodiments A, B, and C may have one or more of the following additional elements in any combination: Element 1: wherein the indention assembly is part of an apparatus comprising: a specimen table with a slot for at least one indenter; and an indention assembly comprising at least one indenter with a force and displacement sensor, wherein the indention assembly is installed under the specimen table such that the indenter may contact a specimen of formation material by extending through the hole, the indenter configured to press against the specimen as the specimen is moved across the specimen table, the indenter including a rolling or sliding indentation tip which dents the specimen. Element 2: further comprising at least one motion sensor on the surface of the specimen table. Element 3: wherein the at least one motion sensor is at least one of mechanical, optical, electromagnetic, and combinations thereof. Element 4: wherein the specimen table has at least one of a flat shape, concave semi-cylindrical shape, and combinations thereof. Element 5: wherein the at least one indenter tip shape is at least one of spherical, pointed, elliptical, wheel, and combinations thereof. Element 6: wherein the specimen is pressed against the indenter by using at least one of hand force, calibrated weight, mechanical means, and combinations thereof. Element 7: wherein the mechanical means is at least one of a spring, a clamp, hydraulic actuator, electromechanical actuator, and combinations thereof. Element 8: further comprising a computer to receive the data from the force and displacement sensors. Element 9: wherein the wellbore diameter measuring device is a caliper assembly. Element 10: wherein the caliper assembly comprises at least one caliper arm, pivotally mounted for radial extension radially outwardly from the tool body to extend the arm tip outward for tip engagement with the surrounding wellbore wall. Element 11: wherein the apparatus is configured to perform at least one of a continuous path of indentations, a series of point indentations, and combinations thereof. Element 12: wherein there are at least two caliper arms and at least two indenters. Element 13: wherein the caliper arms are located on the caliper assembly such that opposite sides of the wellbore face are contacted. Element 14: further comprising a sensor to determine surface roughness.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method for measuring continuous hardness in subterranean formation material, the method comprising:
pressing the tip of an indenter in an indentation assembly against the surface of formation material with a prescribed force;
creating an indentation;
measuring the applied force and the depth of the indentation;
moving at least one of the indenter across the surface of the material, the material across the surface of the indenter, and combinations thereof, with constant axial force applied to the tip of the indenter to create an indentation path; and
measuring applied force, indenter displacement, and lateral displacement while the indenter is creating the indention path, wherein the applied force, indenter displacement, and lateral displacement are used to determine the continuous hardness of the formation material.

2. The method of claim 1, wherein the indention assembly is part of an apparatus comprising:
a specimen table with a slot for at least one indenter; and
an indention assembly comprising at least one indenter with a force and displacement sensor, wherein the indention assembly is installed under the specimen table such that the indenter may contact a specimen of formation material by extending through the hole, the indenter configured to press against the specimen as the specimen is moved across the specimen table, the indenter including a rolling or sliding indentation tip which dents the specimen.

3. The method of claim 2, further comprising at least one motion sensor on the surface of the specimen table.

4. The method of claim 3, wherein the at least one motion sensor is at least one of mechanical, optical, electromagnetic, and combinations thereof.

5. The method of claim 2, wherein the specimen table has at least one of a flat shape, concave semi-cylindrical shape, and combinations thereof.

6. The method of claim 2, wherein the at least one indenter tip shape is at least one of spherical, pointed, elliptical, wheel, and combinations thereof.

7. The method of claim 2, wherein the specimen is pressed against the indenter by using at least one of hand force, calibrated weight, mechanical means, and combinations thereof.

8. The method of claim 2, wherein the mechanical means is at least one of a spring, a clamp, hydraulic actuator, electromechanical actuator, and combinations thereof.

9. The method of claim 2, further comprising a computer to receive the data from the force and displacement sensors.

10. The method of claim 1, wherein the indention assembly is part of an apparatus comprising:
a tool body configured to travel through a wellbore, said tool body comprising: a wellbore diameter measuring device, wherein the wellbore diameter measuring device is configured to provide a base line wellbore geometry; and
an indention assembly, wherein the indention assembly comprises at least one indenter with a force and displacement sensor, the indenter installed behind the wellbore diameter measuring device and configured to press against the wellbore face, the indenter including a rolling or sliding indentation tip which dents the formation.

11. The method of claim 10, wherein the wellbore diameter measuring device is a caliper assembly.

12. The method of claim 11, wherein the caliper assembly comprises at least one caliper arm, pivotally mounted for radial extension radially outwardly from the tool body to extend the arm tip outward for tip engagement with the surrounding wellbore wall.

13. The method of claim 10, wherein the apparatus is configured to perform at least one of a continuous path of indentations, a series of point indentations, and combinations thereof.

14. The method of claim 12, wherein there are at least two caliper arms and at least two indenters.

15. The method of claim 14, wherein the caliper arms are located on the caliper assembly such that opposite sides of the wellbore face are contacted.

16. The method of claim 10, wherein the at least one indenter shape is at least one of spherical, pointed, elliptical, wheel, and combinations thereof.

17. An apparatus for testing continuous hardness in a specimen from a subterranean formation, the apparatus comprising:
a specimen table with a slot for at least one indenter; and
an indention assembly comprising at least one indenter with a force and displacement sensor, wherein the indention assembly is installed under the specimen table such that the indenter may contact a specimen by extending through the slot, the indenter configured to press against the specimen as the specimen is moved across the specimen table, the indenter including a rolling or sliding indentation tip which dents the specimen.

18. The apparatus of claim 17, further comprising at least one motion sensor on the surface of the specimen table.

19. The apparatus of claim 18, wherein the at least one motion sensor is at least one of mechanical, optical, electromagnetic, and combinations thereof.

20. The apparatus of claim 17, wherein the specimen tables has at least one of a flat shape, concave semi-cylindrical shape, and combinations thereof.

21. The apparatus of claim 17, wherein the at least one indenter tip shape is at least one of spherical, pointed, elliptical, wheel, and combinations thereof.

22. The apparatus of claim 17, further comprising a sensor to determine surface roughness.

23. The apparatus of claim 17, wherein the specimen is pressed against the indenter by using at least one of hand force, calibrated weight, mechanical means, and combinations thereof.

24. The apparatus of claim 23, wherein the mechanical means is at least one of a spring, a clamp, hydraulic actuator, electromechanical actuator, and combinations thereof.

25. The apparatus of claim 17, further comprising a computer to receive the data from the force and displacement sensors.

26. An apparatus for testing continuous hardness in a wellbore, the apparatus comprising:
a tool body configured to travel through a wellbore, said tool body comprising: a wellbore diameter measuring device, wherein the wellbore diameter measuring device is configured to provide a base line wellbore geometry; and
an indention assembly, wherein the indention assembly comprises at least one indenter with a force and displacement sensor, the indenter installed behind the wellbore diameter measuring device and configured to press against the wellbore face, the indenter including a rolling or sliding indentation tip which dents the formation.

27. The apparatus of claim 26, wherein the wellbore diameter measuring device is a caliper assembly.

28. The apparatus of claim 27, wherein the caliper assembly comprises at least one caliper arm, pivotally mounted for radial extension radially outwardly from the tool body to extend the arm tip outward for tip engagement with the surrounding wellbore wall.

29. The apparatus of claim 26, wherein the apparatus is configured to perform at least one of a continuous path of indentations, a series of point indentations, and combinations thereof.

30. The apparatus of claim 28, wherein there are at least two caliper arms and at least two indenters.

31. The apparatus of claim 30, wherein the caliper arms are located on the caliper assembly such that opposite sides of the wellbore face are contacted.

32. The apparatus of claim 26, wherein the at least one indenter tip shape is at least one of spherical, pointed, elliptical, wheel, and combinations thereof.
